(19) United States
(12) Patent Application Publication
(10) Pub. No.: US 2004/0060182 A1
(43) Pub. Date: Apr. 1, 2004

(54) Method and apparatus for laying paving stones

(76) Inventor: Kirk Plummer, Surrey (CA)

Correspondence Address: Vermette & Co., Granville Square, Box 40, 230-200 Granville Street, Vancouver, BC, V6C 1S4, CA

(21) Appl. No.: 10/214,133

(22) Filed: Aug. 8, 2002

(51) Int. Cl. G01D 21/00

(52) U.S. Cl. 33/526

(57) ABSTRACT

The invention consists of an apparatus for facilitating the uniform placement of paving stones and similar construction materials. The apparatus is comprised of a lattice formed from a series of spaced apart ribs defining a pattern of holes. The holes mark the locations for placing bricks. The lattice is designed to remain part of the structure after the bricks are secured and is sufficiently rigid to provide support for paving stones located at the perimeter of the lattice.

### FIELD

This invention relates to an apparatus for use in laying paving stones and similar items and a method of using the same.

### BACKGROUND

One of the difficulties when laying paving stones or similar items on a surface is ensuring the uniformity of the pattern created by the stones. A related problem is to prevent the stones from moving once they are laid on the surface, but before they are secured.

One approach to solving this problem is the use of a template placed over the surface allowing the stones to be laid in a desired pattern reflected by the template. The template is then typically removed and the spaces between the stones filled with sand or a similar granular substance. The outer stones are typically held in place by boards or a concrete perimeter.

An example of this kind of removable template as used in bricklaying is found in U.S. Pat. No. 5,459,938 issued to Knight et al. Knight discloses a guide for bricklaying that consists of a rigid lattice framework having square openings. The lattice is laid down on a prepared work surface and the bricks are inserted into the openings in the lattice. The lattice is then removed and the bricks are secured into place. The Knight lattice is hinged in the center and has protruding handles to allow it to be easily carried to a work site and removed after the bricks are laid.

While the Knight template is of assistance in laying bricks, the design leaves some problems to be addressed for use with paving stones. The first problem is that the lattice is removed after the bricks are placed, but before they are fully secured. As a result, the risk of the stones shifting or moving before or while the sand is poured is still present. This risk is more pronounced on the stones around the edge of the area.

A second problem arises from the nature of the Knight lattice itself. As a fully rigid framework, the lattice cannot be made very large before becoming unwieldy to move and lift. Therefore, it is unsuitable for a large project or large patterns.

Therefore, it is an object of this invention to provide an apparatus for laying paving stones that remains part of the finished structure.

It is a further object of this invention to provide an apparatus for laying paving stones that is sufficiently flexible to be easily portable while maintaining sufficient rigidity to provide support for the paving stones at or near the perimeter of the pattern.

It is a still further object of this invention to provide an apparatus for laying paving stones that can be adapted for use with any shape or pattern of paving stone.

### SUMMARY OF THE INVENTION

The invention consists of an apparatus for facilitating the uniform placement of paving stones and similar construction materials. The apparatus is comprised of a lattice formed from a series of spaced apart ribs defining a pattern of holes. The holes mark the locations for placing paving stones. The lattice is designed to remain part of the structure after the paving stones are secured.

The lattice is sufficiently rigid to provide support for the paving stones on the perimeter of the pattern, while being flexible enough to be rolled or folded to facilitate transportation and storage.

The invention further includes a method of using the above apparatus for laying pacing stones in a prepared work area.

### BRIEF DESCRIPTION OF THE DRAWINGS

The invention itself both as to organization and method of operation, as well as additional objects and advantages thereof, will become readily apparent from the following detailed description when read in connection with the accompanying drawings:

FIG. 1 is a rectangular lattice for use in laying paving stones; and

FIG. 2 shows two adjacent rectangular lattices.

### DETAILED DESCRIPTION

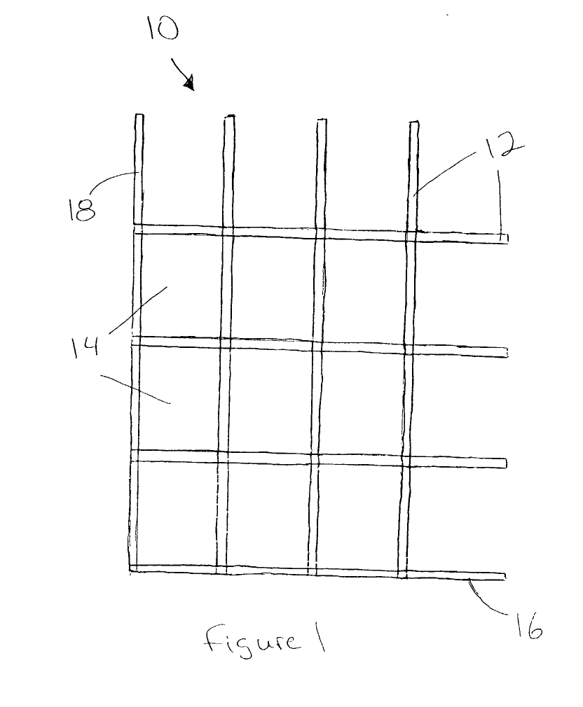

In FIG. 1, a typical lattice 10 is shown. The lattice is comprised of a number of regularly spaced ribs 12 the spaces between which define holes 14. The perimeter of the lattice is defined by ribs 16 and 18 along two sides, with the other two sides lacking perimeter ribs. In the lattice 10 shown, the holes are rectangular in nature, however, any shape and pattern can be used, with octagonal and rhomboid patterns being among most common other shapes used for paving stones.

The lattice 10 is formed from a resilient and flexible material, preferably a plastic such as polypropylene. As a result, the lattice 10 can be folded or rolled as necessary to reduce the amount of space required for storage and to make it easier to transport around a work site. The lattice 10 is then unfolded (or unrolled) as necessary at the work site where it is placed.

The ribs 12 of the lattice 10 should be of a thickness equal to the required spacing distance for the stones in the direction corresponding to the plane of the lattice. In the direction orthogonal to the plane of the lattice, the ribs 12 need only be sufficiently thick to prevent the stone from moving once in place. This allows for the lattice 10 to remain flexible as described above. This also allows for the lattice 10 to be cut if necessary to accommodate irregular areas or obstacles such as pillars. By cutting the lattice 10 first, it then becomes much easier to cut the stones to the necessary shape, as the required dimensions of the stones can be readily determined by looking at the cut lattice.

The use of the lattice 10 to lay paving stones requires little adjustment to the standard construction practices. First, the work area on which the stones are to be laid must be prepared as usual. Then the lattice 10 is laid over the work area. One or two initial stones are placed in the holes 14 of the lattice 10 to ensure the lattice 10 remains in position. The remaining stones are placed in the remaining holes 14 and the spaces between the stones, defined by the ribs 12 of the lattices 10, are filled with sand to help stabilize the stones against movement. The lattice 10 holds the paving stones in place, particularly those along the perimeter, which are not restrained from moving by surrounding stones. Clean-up and finishing can then take place as per conventional construction practice.

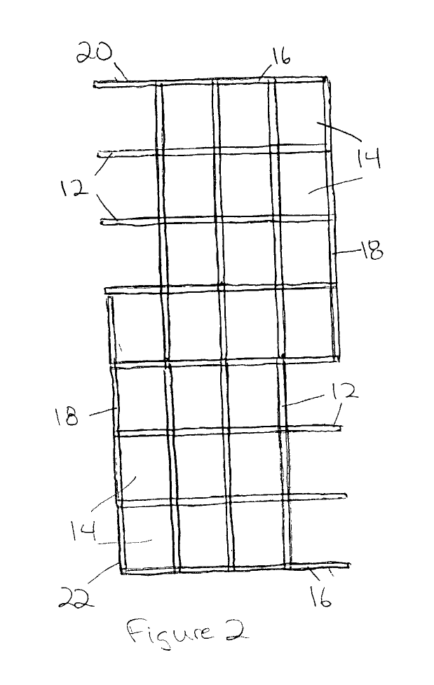

If multiple lattices are used, as shown in FIG. 2, the lattices 20 and 22 are positioned such that the perimeter ribs 16 and 18 match the perimeter of the work area. The ribs 12 on the sides without perimeter ribs are cut to ensure that neighboring lattices do not have overlapping ribs. In some cases, this may result in some paving stones only being bounded by ribs on three sides (for rectangular or square holes). However, this will prove sufficient to hold the stones in place while the spaces between the stones are filled with sand.

When using multiple lattices, depending on the nature of the work area, all the lattices can be laid down at once, each held in place by one or two paving stones as described above. Alternatively, one lattice can be laid down to start, and once all the holes in that lattice are filled with paving stones, the next lattices is laid down adjacent to the filled lattice and the process is repeated.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the scope of the invention.

What is claimed is:

1. An apparatus for facilitating the uniform placement of paving stones, comprising a lattice formed from a series of spaced apart ribs defining a pattern of holes, said holes marking locations for placing said paving stones, and said lattice being sufficiently rigid to provide support to paving stones located at the perimeter of said lattice, wherein said lattice remains in place after said paving stones are secured.

2. An apparatus according to claim 1, wherein said lattice has ribs on its outer perimeter on two adjacent sides.

3. An apparatus according to claim 1, wherein said lattice is rectangular in shape.

4. An apparatus according to claim 1, wherein said holes are rectangular in shape.

5. A method of laying paving stones on a prepared substrate, comprising:
(a) covering said substrate with one or more lattices formed from a series of spaced apart ribs defining a pattern of holes, said holes marking locations for placing bricks, said lattices being sufficiently rigid to support paving stones located at a perimeter of said substrate;
(b) placing paving stones in said holes defined by said lattice; and
(c) filling gaps between said paving stones defined by said ribs of said flexible lattice with a granular material or mortar.

6. A method according to claim 5, including an additional step prior to step (b) of cutting ribs on one or more of said lattices to eliminate overlap between adjacent lattices.

7. A method according to claim 5, wherein additional lattices are laid sequentially as a preceding adjacent lattice is filled with paving stones.
